(19) United States
(12) Patent Application Publication
(10) Pub. No.: US 2011/0059248 A1
(43) Pub. Date: Mar. 10, 2011

(54) COATING METHOD AND COATING APPARATUS

(75) Inventors: Hidenori MIYAMOTO, Kawasaki-shi (JP); Kenji MARUYAMA, Kawasaki-shi (JP); Tadahiko HIRAKAWA, Kawasaki-shi (JP); Koichi MISUMI, Kawasaki-shi (JP)

(73) Assignee: TOKYO OHKA KOGYO CO., LTD., Kawasaki-shi (JP)

(21) Appl. No.: 12/871,710

(22) Filed: Aug. 30, 2010

(30) Foreign Application Priority Data
Sep. 8, 2009 (JP) 2009-207142

(51) Int. Cl. B05D 3/02; B05C 9/14

(52) U.S. Cl. 427/372.2; 118/58; 118/666

(57) ABSTRACT

A coating method including coating a liquid material including an oxidizable metal on a substrate, and heating the substrate having the liquid material coated thereon in the presence of an inert gas.

### BACKGROUND OF THE INVENTION

1. Field of the Invention

The present invention relates to a coating apparatus and a coating method.

2. Description of the Related Art

A CIGS solar cell formed by semiconductor materials including a metal such as Cu, Ge, Sn, Pb, Sb, Bi, Ga, In, Ti, and a combination thereof, and a chalcogen element such as S, Se, Te, and a combination thereof has been attracting attention as a solar cell having high conversion efficiency (for example, see Patent Documents 1 and 2). For example, a CIGS solar cell has a structure in which a film including four types of semiconductor materials, namely, Cu, In, Ga, and Se is used as a light absorbing layer (photoelectric conversion layer).

In a CIGS solar cell, since it is possible to reduce the thickness of the light absorbing layer compared to a conventional solar cell, it is easy to install the CIGS solar cell on a curved surface and to transport the CIGS solar cell. For this reason, it is expected that CIGS solar cells can be used in various application fields as a high-performance, flexible solar cell. As a method of forming the light absorbing layer, a method of forming the light absorbing layer through depositing or sputtering is conventionally known (for example, see Patent Documents 2 to 4).

### DOCUMENTS OF RELATED ART

### Patent Documents

[Patent Document 1] Japanese Unexamined Patent Application, First Publication No. Hei 11-340482

[Patent Document 2] Japanese Unexamined Patent Application, First Publication No. 2005-51224

[Patent Document 3] Japanese Unexamined Patent Application, First Publication No. Hei 1-231313

[Patent Document 4] Japanese Unexamined Patent Application, First Publication No. Hei 11-273783

[Patent Document 5] Japanese Unexamined Patent Application, First Publication No. 2005-175344

By contrast, as the method of forming the light absorbing layer, the present inventor propose a method of coating the semiconductor materials in the form of a liquid material on a substrate. In such a method of forming the light absorbing layer by coating the semiconductor materials in the form of a liquid material, the following problems arise.

Among the semiconductor materials, Cu, In, and the like are metals susceptible to oxidation (i.e., oxidizable metals). When a liquid material including such oxidized metals is coated on the substrate under the conditions in which the oxygen concentration or humidity is high, the oxidizable metal is likely to be oxidized, which may cause deterioration in the film quality of the coating film. This problem is not limited to the case of forming a semiconductor film of a CIGS solar cell, but may generally arise in a coating operation using a liquid material including the oxidizable metals.

In order to solve the above-described problem, for example, as described in Patent Document 5, a technology has been proposed in which a main chamber is maintained in a hermetic state by a nitrogen-circulation cleaning unit and nitrogen is circulated via a high-performance filter so as to maintain a clean state. However, since a coating operation is performed using an organic material such as a photoresist as a target solution and metal is not a main component thereof, it is difficult to solve the above-described problem.

### SUMMARY OF THE INVENTION

The present invention takes the above circumstances into consideration, with an object of providing a coating apparatus and a coating method capable of suppressing deterioration in the film quality of a coating film including oxidizable metal.

The coating method according to the present invention includes coating a liquid material including an oxidizable metal on a substrate (coating step); and heating the substrate having the liquid material coated thereon in the presence of an inert gas (heating step).

According to the present invention, by virtue of coating a liquid material including an oxidizable metal on a substrate and heating the substrate in the presence of an inert gas, it is possible to reliably suppress deterioration in the film quality of a coating film containing an oxidizable metal.

In the coating method, the heating step may be performed while disposing the substrate inside the chamber.

In this embodiment, since the substrate is heated while being disposed inside the chamber, the liquid material on the substrate can be prevented from coming in contact with the outside air. As a result, it becomes possible to prevent oxidation of the oxidizable metal contained in the liquid material.

In the coating method, the heating step may be performed in an inert gas atmosphere.

In this embodiment, by virtue of heating the liquid material in an inert gas atmosphere, the oxidizable metal contained in the liquid material can be prevented from being oxidized in the heating step. As a result, it is possible to prevent deterioration in the film quality of the coating film.

In the coating step, the heating step may include supplying an inert gas to the surrounding atmosphere of the substrate (supplying step).

In this embodiment, since an inert gas is supplied to the surrounding atmosphere of the substrate, the surrounding atmosphere can be easily changed to an inert gas atmosphere.

In the coating step, the heating step may include discharging the gas in the surrounding atmosphere of the substrate (discharging step).

In this embodiment, by virtue of performing the heating step while discharging the gas in the surrounding atmosphere of the substrate, retention of oxygen and moisture in the surrounding atmosphere can be prevented. As a result, it becomes possible to suppress oxidation of the oxidizable metal contained in the liquid material.

In the coating method, the heating step may include returning the discharged gas to the surrounding atmosphere of the substrate (returning step).

In this embodiment, by returning the discharged gas to the surrounding atmosphere of the substrate, the temperature of the gas can be adjusted, so as to reuse the gas supplied to the surrounding atmosphere of the substrate. Thus, time can be saved for resetting the temperature conditions and the like of the gas supplied to the surrounding atmosphere of the substrate. As a result, the gas can be efficiently supplied into the chamber.

In the coating method, the heating step may include heating the discharged gas before being returned to the surrounding atmosphere of the substrate (gas heating step).

In this embodiment, by virtue of heating the discharged gas before returning it to the surrounding atmosphere of the substrate, the temperature of the gas can be adjusted in the returning step.

In the coating method, the gas heating step may be conducted by using excess heat in the surrounding atmosphere of the substrate.

In this embodiment, since the excess heat in the surrounding atmosphere is used to heat the gas before returning it, the temperature of the gas can be adjusted to a temperature close to the temperature of the surrounding atmosphere of the substrate. In this manner, the temperature of the gas can be easily adjusted.

In the coating method, the substrate may include a resin material, and the heating step may be performed while maintaining the temperature inside the chamber at 300° C. or lower.

In this embodiment, since the heating step is performed while maintaining the temperature inside the chamber at 300° C. or lower, even when a substrate made of a resin material is used, the heat treatment can be performed without deformation of the substrate. Hence, the substrate can be selected from a variety of materials.

The coating apparatus according to the present invention includes a coating part which applies a liquid material including an oxidizable metal to a substrate; a chamber having a coating space in which the coating part applies the liquid material to the substrate and a transport space into which the substrate is transported; a heating mechanism which heats the substrate inside the chamber; and a control part which controls the coating part and the heating mechanism to heat the substrate having the liquid material coated thereon in the presence of an inert gas.

According to the present invention, since the substrate coated with the liquid material can be heated in the presence of an inert gas, it is possible to suppress deterioration in the film quality of a coating film containing an oxidizable metal.

The coating apparatus may further include a supplying mechanism which supplies an inert gas into the chamber.

In this embodiment, since the atmosphere inside the chamber can be changed to an inert gas atmosphere and the liquid material can heated therein, the oxidizable metal contained in the liquid material can be prevented from being oxidized in the heating step. As a result, it is possible to prevent deterioration in the film quality of the coating film.

The coating apparatus may further include a discharging mechanism which discharges the gas inside the chamber.

In this embodiment, by virtue of performing the heating step while discharging the gas in the surrounding atmosphere of the substrate, retention of oxygen and moisture in the surrounding atmosphere can be prevented. As a result, it becomes possible to suppress oxidation of the oxidizable metal contained in the liquid material.

In the coating apparatus, the discharging mechanism may include a circulation path which returns the discharged gas to the surrounding atmosphere of the substrate.

In this embodiment, by returning the discharged gas to the surrounding atmosphere of the substrate, the temperature of the gas can be adjusted, so as to reuse the gas supplied to the surrounding atmosphere of the substrate. Thus, time can be saved for resetting the temperature conditions and the like of the gas supplied to the surrounding atmosphere of the substrate. As a result, the gas can be efficiently supplied into the chamber.

In the coating apparatus, the discharging mechanism may have a gas heating mechanism which heats the discharged gas in the circulation path.

In this embodiment, by virtue of heating the discharged gas before returning it to the surrounding atmosphere of the substrate, the temperature of the gas can be adjusted in the returning step.

In the coating apparatus, the gas heating mechanism may have a heat accumulating mechanism which stores excess heat generated inside the chamber.

In this embodiment, since the excess heat in the surrounding atmosphere is used to heat the gas before returning it, the temperature of the gas can be adjusted to a temperature close to the temperature of the surrounding atmosphere of the substrate. In this manner, the temperature of the gas can be easily adjusted.

In the coating method, the substrate may include a resin material, and the control part may heat the inside of the chamber to a temperature of 300° C. or lower.

In this embodiment, since the heating step is performed while maintaining the temperature inside the chamber at 300° C. or lower, even when a substrate made of a resin material is used, the heat treatment can be performed without deformation of the substrate. Hence, the substrate can be selected from a variety of materials.

Thus, according to the present invention, it is possible to suppress deterioration in the film quality of the coating film.

### BRIEF DESCRIPTION OF THE DRAWINGS

FIG. 1 is a diagram showing a configuration of a coating apparatus according to one embodiment of the present invention.

FIG. 2 is a diagram showing a configuration of a part of the coating apparatus according to one embodiment of the present invention.

FIG. 3 is a diagram showing an operation of the coating apparatus according to one embodiment of the present invention.

FIG. 4 is a diagram showing an operation of the coating apparatus according to one embodiment of the present invention.

FIG. 5 is a diagram showing an operation of the coating apparatus according to one embodiment of the present invention.

FIG. 6 is a diagram showing a configuration of a coating apparatus according to another embodiment of the present invention.

### DETAILED DESCRIPTION OF THE INVENTION

Hereinafter, one embodiment of the present invention will be described with reference to the accompanying drawings.

In the respective drawings as below, upon describing the configuration of a coating apparatus, for the purpose of simple marking, an XYZ coordinate system is used to describe the directions in the drawings. In the XYZ coordinate system, the horizontal direction in the drawing is marked as the X direction, and the direction perpendicular to the X direction in a plan view is marked as the Y direction. The direction perpendicular to a plane including the X and Y axes is marked as the Z direction. In the X, Y, and Z directions, the arrow direction in the drawing is the +direction, and the opposite direction of the arrow direction is the −direction.

### First Embodiment

### Coating Apparatus

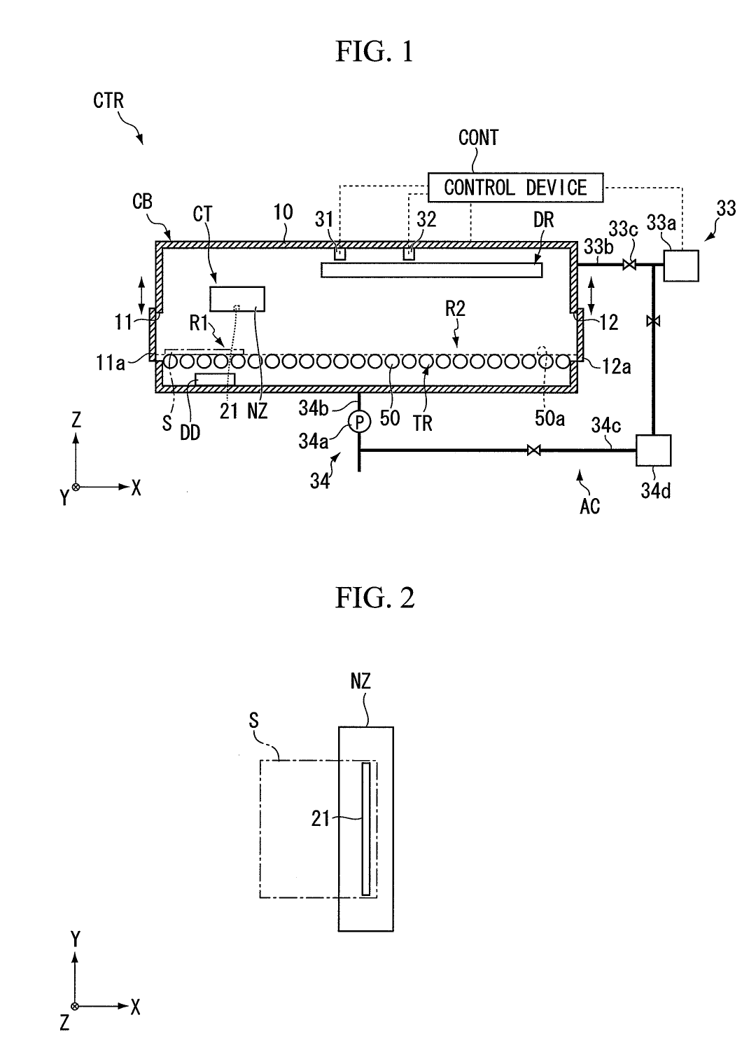

FIG. 1 is a schematic diagram showing a configuration of a coating apparatus CTR according to one embodiment of the present invention.

As shown in FIG. 1, the coating apparatus CTR includes a chamber CB, a coating part CT, a condition adjusting part AC, a heating part DR, a substrate transporting part TR, and a control device CONT. The coating apparatus CTR is an apparatus which applies a liquid material on a substrate S inside the chamber CB.

In this embodiment, as the liquid material, for example, a liquid composition is used which includes a solvent such as hydrazine and oxidizable metals such as copper (Cu), indium (In), gallium (Ga), and selenium (Se). The liquid composition includes a metal material for forming a light absorbing layer (photoelectric conversion layer) of a CIGS solar cell. Needless to say, as the liquid material, a liquid material in which another oxidizable metal is dispersed in the solution may be used. In this embodiment, as the substrate S, for example, a plate-shaped member made of glass, resin, or the like may be used.

(Chamber)

The chamber CB includes a housing 10, a substrate loading opening 11, and a substrate unloading opening 12. The housing 10 is adapted to accommodate the substrate S. The substrate loading opening 11 and the substrate unloading opening 12 are openings formed in the housing 10. The substrate loading opening 11 is formed in, for example, the −X-direction-side end portion of the housing 10. The substrate unloading opening 12 is formed in, for example, the +X-direction-side end portion of the housing 10. The substrate loading opening 11 and the substrate unloading opening 12 are connected to, for example, a load lock chamber (not shown).

The substrate loading opening 11 is provided with a shutter member 11a. The shutter member 11a is adapted to be movable in the Z direction, and is adapted to open or close the substrate loading opening 11. The substrate unloading opening 12 is provided with a shutter member 12a. In the same manner as the shutter member 11a, the shutter member 12a is adapted to be movable in the Z direction, and is adapted to open or close the substrate unloading opening 12. When the shutter members 11a and 12a are both in a closed state, the inside of the chamber CB is hermetically closed. FIG. 1 shows the state in which the shutter members 11a and 12a are closed.

(Coating Part)

The coating part CT is accommodated in the housing 10 of the chamber CB. The coating part CT includes a slit nozzle NZ which is formed in an elongated shape. The slit nozzle NZ is provided, for example, in the vicinity of the substrate loading opening 11 inside the chamber CB. The slit nozzle NZ is formed to be elongated in, for example, the Y direction.

FIG. 2 is a diagram showing a configuration of the slit nozzle NZ. FIG. 2 shows the configuration when the slit nozzle NZ is viewed from the −Z direction side thereof to the +Z direction side thereof.

As shown in FIG. 2, the slit nozzle NZ has a nozzle opening 21. The nozzle opening 21 is an opening for ejecting a liquid material. The nozzle opening 21 is formed in, for example, the Y direction so as to follow the longitudinal direction of the slit nozzle NZ. The nozzle opening 21 is formed, for example, so that the longitudinal direction thereof is substantially equal to the Y-direction dimension of the substrate S.

The slit nozzle NZ ejects, for example, a liquid material in which four types of metals, namely, Cu, In, Ga, and Se are mixed with a predetermined composition ratio. The slit nozzle NZ is connected to a supply source (not shown) of the liquid material via a connection pipe (not shown). The slit nozzle NZ includes a holding portion which holds the liquid material therein. The slit nozzle NZ includes a temperature controlling mechanism (not shown) which controls the temperature of the liquid material held by the holding portion.

The slit nozzle NZ is provided with, for example, a moving mechanism (not shown) which is adapted to be movable between, for example, a standby position and a coating position (a position shown in FIG. 1) inside the chamber CB. The standby position of the slit nozzle NZ is provided with, for example, a dummy ejection mechanism DD which conducts a dummy ejection of the liquid material. The dummy ejection mechanism is provided with, for example, a bubble sensor (not shown) which detects a bubble of the liquid material.

(Condition Adjusting Part)

Returning to FIG. 1, the condition adjusting part AC includes an oxygen concentration sensor 31, a pressure sensor 32, an inert gas supply part 33, and a discharge part 34.

The oxygen concentration sensor 31 detects the oxygen concentration inside the chamber CB, and transmits the detection result to the control device CONT. The pressure sensor 32 detects a pressure inside the chamber CB, and transmits the detection result to the control device CONT. There may be plural numbers of the oxygen concentration sensors 31 and the pressure sensors 32. In FIG. 1, the oxygen concentration sensor 31 and the pressure sensor 32 are mounted to the ceiling portion of the housing 10 of the chamber CB, although they may be provided in other portions.

The inert gas supply part 33 supplies, for example, an inert gas such as nitrogen gas, argon gas or helium gas to the inside of the housing 10 of the chamber CB. The inert gas supply part 33 includes a gas supply source 33a, a conduit 33b, and a supply amount adjusting part 33c. As the gas supply source 33a, for example, a gas cylinder or the like may be used.

One end of the conduit 33b is connected to the gas supply source 33a, and the other end thereof is connected to the inside of the housing 10 of the chamber CB. The end portion of the conduit 33b connected to the chamber CB is an inert gas supply port in the chamber CB. The inert gas supply port is disposed on the +Z direction side of the housing 10.

The supply amount adjusting part 33c is a part which adjusts the amount of the inert gas supplied to the inside of the housing 10. As the supply amount adjusting part 33c, for example, an electromagnetic valve or a valve which is manually opened or closed may be used. The supply amount adjusting part 33c is provided in, for example, the conduit 33b. The supply amount adjusting part 33c may be directly installed in, for example, the gas supply source 33a, instead of disposing in the conduit 33b.

The discharge part 34 discharges a gas inside the housing 10 of the chamber CB to the outside of the housing 10. Further, the discharge part 34 may be used to discharge the gas inside the housing 10 of the chamber CB to thereby reduce the pressure inside the housing 10. The discharge part 34 includes a discharge driving source 34a, a conduit 34b, a conduit 34c, and a removing member 34d. The discharge driving source 34a is connected to the inside of the housing 10 via the conduit 34b. As the discharge driving source 34a, for example, a pump or the like may be used. The conduit 34b has a discharge port which is provided in an end portion thereof provided inside the housing 10. The discharge port is disposed on the −Z direction side of the housing 10.

By such a configuration in which the inert gas supply port is disposed on the +Z direction side of the housing 10 and the discharge port is disposed on the −Z direction side of the housing 10, the gas inside the housing 10 flows in the −Z direction. In this manner, it is possible to suppress the gas inside the housing 10 from whirling around.

One end of the conduit 34c is connected to the discharge driving source 34a, and the other end thereof is connected to the conduit 33b of the inert gas supply part 33. The conduit 34c is used as a circulation path which circulates the gas discharged by the discharge driving source 34a from the inside of the housing 10 to the supply path. In this manner, the discharge part 34 is also used as a circulating mechanism which circulates the gas inside the housing 10. The connection portion of the conduit 34c is not limited to the conduit 33b of the inert gas supply part 33, but for example, the conduit 34c may be directly connected to the inside of the housing 10. In the conduit 34c, for example, valves are respectively provided on the upstream side and the downstream side of a removing member 34d.

The removing member 34d is provided inside the conduit 34c. As the removing member 34d, for example, an absorbing material for absorbing an oxygen component and moisture contained in the gas circulating in the conduit 34c is used. In this manner, it is possible to clean the circulated gas. The removing member 34d may be disposed at one position inside the conduit 34c, or may be disposed throughout the conduit 34c.

(Heating Part)

The heating part DR is a part which dries the liquid material coated on the substrate S. The heating part DR includes a heating mechanism such as an infrared unit. The heating part DR is adapted to heat and dry the liquid material by using the heating mechanism. The heating part DR is provided at a position not overlapping with the nozzle NZ in plan view. More specifically, the heating part DR is disposed on the +X direction side of the slit nozzle NZ. For this reason, the action of the heating part DR (e.g., irradiation of infrared ray) hardly influences the slit nozzle NZ, and thus the liquid material inside the slit nozzle NZ is hardly dried. By such a configuration in which the heating part DR is not disposed on the +Z direction side of the slit nozzle NZ, it is possible to prevent clogging of the nozzle opening 21 formed in the nozzle NZ, thereby preventing a change in quality of the liquid composition including the oxidizable metal materials.

(Substrate Transporting Part)

The substrate transporting part TR is a part which transports the substrate S inside the housing 10. The substrate transporting part TR includes a plurality of roller members 50. The roller members 50 are arranged in the X direction from the substrate loading opening 11 to the substrate unloading opening 12. Each roller member 50 is adapted to be rotatable about the Y direction serving as the central axis.

The plurality of roller members 50 are formed to have the same diameter, and are disposed at the same position in the Z direction. The +Z-direction-side upper ends of the roller members 50 are adapted to support the substrate S. For this reason, the support positions of the roller members 50 are formed on the same plane, and a transporting plane 50a for the substrate S is formed by the plural roller members 50.

The transporting plane 50a for the substrate S is formed so that a loading position of the substrate S at the substrate loading opening 11 and an unloading position of the substrate S at the substrate unloading opening 12 are equal to each other in the Z direction. In this manner, the substrate S is reliably transported from the substrate loading opening 11 to the substrate unloading opening 12 without any change in the Z-direction position thereof.

In the space above the substrate transporting plane 50a inside the chamber CB, a space on the −Z direction side of the slit nozzle NZ becomes a coating space R1 where the liquid material is applied on the substrate S. In the space above the substrate transporting plane 50a inside the chamber CB, a space on the +X direction side of the slit nozzle NZ becomes a transport space R2 (transporting space R2) where the substrate S coated with the liquid material is transported.

(Control Device)

The control device CONT is a part which has the overall control of the coating apparatus CTR. More specifically, the control device CONT controls, for example, an opening-closing operation using the shutter members 11a and 12a of the chamber CB, a transporting operation using the substrate transporting part TR, a coating operation using the coating part CT, a drying operation using the heating part DR, and an adjusting operation using the condition adjusting part AC. As an example of the adjusting operation, the control device CONT controls an opening degree of the supply amount adjusting part 33c of the inert gas supply part 33 on the basis of the detection result obtained by the oxygen concentration sensor 31 and the pressure sensor 32, and/or controls the recovering operation of the recovering unit 62. The control device has a timer or the like (not shown) for measuring the treatment time.

[Coating Method]

Next, a coating method according to one embodiment of the present invention will be described. In this embodiment, a coating film is formed on the substrate S by using the coating apparatus CTR having the above-described configuration. The operations performed by the respective portions of the coating apparatus CTR are controlled by the control device CONT.

The control device CONT adjusts the atmosphere inside the chamber CB to be an inert gas atmosphere. More specifically, an inert gas is supplied to the inside of the chamber CB by using the inert gas supply part 33. In this case, the control device CONT may adjust the pressure inside the chamber CB by appropriately operating the discharge part 34.

In addition, the control device CONT controls the holding portion of the slit nozzle NZ to hold the liquid material therein. The control device CONT controls the temperature of the liquid material held by the holding portion by using the temperature controlling mechanism inside the slit nozzle NZ. In this manner, the control device CONT controls the slits nozzle NZ so as to be in a state capable of ejecting the liquid material to the substrate S.

When the coating apparatus CTR is in the state capable of ejecting the liquid material to the substrate S, the control device CONT loads the substrate S from the load lock chamber into the chamber CB. More specifically, the control device CONT moves up the shutter member 11a of the substrate loading opening 11, and loads the substrate S into the chamber CB via the substrate loading opening 11.

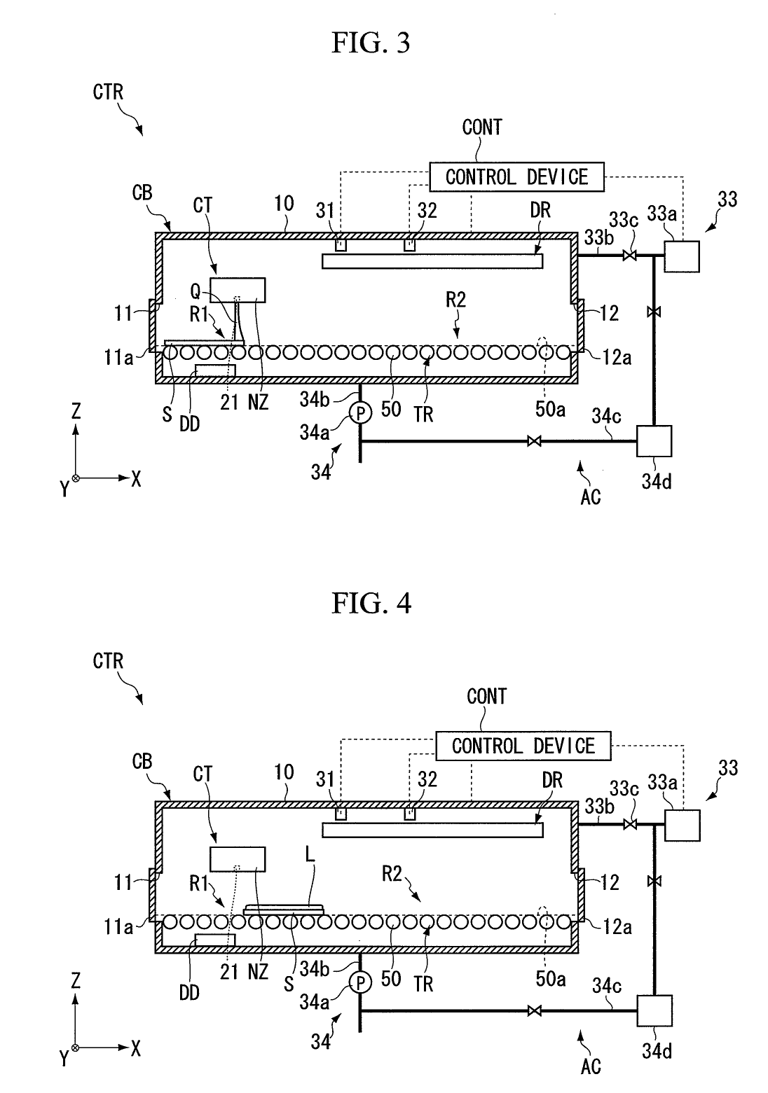

After the substrate S is loaded into the chamber CB, the control device CONT rotates the roller members 50 of the substrate transporting part TR so as to move the substrate S in the +X direction. When the +X-direction-side edge of the substrate S arrives at a position overlapping with the nozzle opening 21 of the slit nozzle NZ as viewed from the Z direction, as shown in FIG. 3, the control device CONT operates the slit nozzle NZ so as to eject a liquid material Q from the nozzle opening 21.

The control device CONT rotates the roller members 50 while ejecting the liquid material Q from the nozzle opening 21 in the state where the position of the slit nozzle NZ is fixed. By this operation, the liquid material is coated on the substrate S from the +X direction side thereof to the −X direction side thereof in accordance with the movement of the substrate S. As shown in FIG. 4, a coating film L of the liquid material is formed on a predetermined area of the substrate S (coating step). After the coating film L is formed on the substrate S, the control device CONT stops the operation of ejecting the liquid material from the nozzle opening 21.

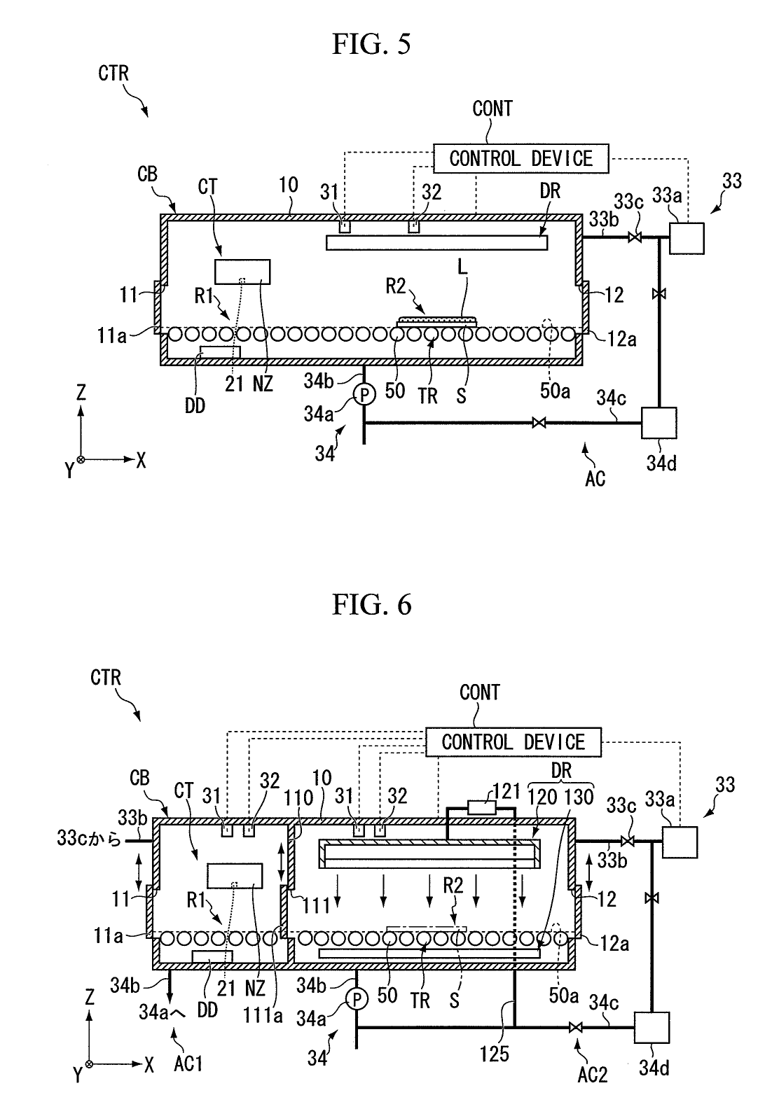

After the ejecting operation stops, as shown in FIG. 5, the control device CONT transports the substrate S to a position on the −Z side of the heating part DR, and then operates the discharge part 34 to reduce the pressure inside the chamber CB. After the pressure inside the chamber CB has been reduced, the control device CONT operates the heating part DR to heat the coated film on the substrate (heating step). By heating the liquid material under reduced pressure, the liquid material can be efficiently dried in a short time.

In the heating step, for example, the heating temperature can be controlled to be 300° C. or lower. By controlling the heating temperature to be 300° C. or lower, even when the substrate S is made of a resin material, the heat treatment can be performed without deformation of the substrate S. Hence, the substrate S can be selected from a variety of materials.

The control device CONT, for example, stops the rotation operation of the roller members 50, and operates the heating part DR while the substrate S is in a stationary state. For example, the time required for drying the coating film L on the substrate S and/or the heating temperature is memorized in advance, and the control device CONT performs a heating operation of the coating film L by controlling the heating time and the heating temperature on the basis of the memorized values.

In the case where a part of a light absorbing layer is formed by coating the liquid material Q including oxidizable metals on the substrate S, for example, since Cu, In and the like are metals which are susceptible to oxidation (oxidizable metals), when the oxygen concentration inside the chamber CB is high, the oxidizable metals are oxidized. When the metals are oxidized, the film quality of the coating film formed on the substrate S may deteriorate.

In the present embodiment, the control device CONT uses the condition adjusting part AC to adjust the atmosphere inside the chamber CB to become an inert gas atmosphere. More specifically, the control device CONT supplies an inert gas such as a nitrogen gas or an argon gas to the inside of the chamber CB by using the inert gas supply part 33 (supplying step).

In the supplying step, the control device CONT first detects the oxygen concentration inside the chamber CB by using the oxygen concentration sensor 31. The control device CONT adjusts the inert gas supply amount by using the supply amount adjusting part 33c on the basis of the detection result obtained in the detecting step, and supplies the inert gas to the inside of the chamber CB. For example, when the detected oxygen concentration exceeds a predetermined threshold value, it is possible to supply the inert gas into the chamber CB. The threshold value may be obtained in advance by a test or simulation, and may be stored in the control device CONT. In addition, for example, a predetermined amount of the inert gas may be constantly supplied into the chamber CB during the coating operation and the drying operation, and the inert gas supply amount can be increased or decreased on the basis of the detection result of the oxygen concentration sensor 31.

In the supplying step, the control device CONT uses the oxygen concentration sensor 31, and also detects the atmospheric pressure inside the chamber CB by using the pressure sensor 32. The control device CONT supplies the inert gas to the inside of the chamber CB while adjusting the gas supply amount of the inert gas by using the supply amount adjusting part 33c on the basis of the detection result of the pressure sensor 32. For example, when the atmospheric pressure inside the chamber CB exceeds a predetermined threshold value, the gas inside the chamber CB is discharged by using the discharge part 34. This threshold value may be obtained in advance by a test or simulation, and may be stored in the control device CONT. In addition, for example, a predetermined amount of the gas inside the chamber CB may be constantly discharged during the coating operation and the drying operation, and the discharge amount can be increased or decreased on the basis of the detection result of the pressure sensor 32. In this manner, the inside of the chamber can be maintained under reduced pressure.

The gas discharged from the discharge part 34 is circulated to the conduit 33b of the inert gas supply part 33 via the conduits 34b and 34c. When the gas flows through the conduit 34c, the gas passes through the removing member 34d. When the gas passes through the removing member 34d, the oxygen component in the gas is adsorbed by the removing member 34d so as to be removed from the gas. In this manner, an inert gas having a low oxygen concentration is circulated to the conduit 33b. By circulating the gas inside the chamber CB, it becomes possible to supply the inert gas under stable temperature conditions.

According to the present embodiment, by virtue of coating a liquid material including an oxidizable metal on a substrate S and heating the substrate S in the presence of an inert gas, it is possible to suppress deterioration in the film quality of the coating film L containing an oxidizable metal.

### Second Embodiment

Next, a second embodiment of the present invention will be described. In this embodiment, the configuration of the chamber CB and the heating part DR is different from that of the first embodiment. Therefore, the differing points will be mainly described below. FIG. 6 is a schematic diagram showing a configuration of a coating apparatus CTR according to the present embodiment.

As shown in FIG. 6, in the present embodiment, the inside of the chamber CB is partitioned into two sections, so that the slit nozzle NZ and the heating part DR are disposed in different sections. A partition member 110 is provided inside the chamber CB. The partition member 110 is arranged on the transporting path of the substrate S. Therefore, the substrate S is transported so as to pass through the partition member 110.

The partition member 110 is provided with an opening 111 formed in a region corresponding to the height position (a position in the Z direction) of the substrate S. The opening 111 is provided with a cover portion 111a so as to open or close the opening 111. When transporting the substrate S, the cover portion 111a is in an open state while the substrate S passes through the partition member 111. When the substrate S does not pass through the partition member 111 or a process is being performed in each section, the cover portion 111a is in a closed state.

An oxygen concentration sensor 31 which detects the oxygen concentration inside the chamber CB and a pressure sensor 32 which detects the pressure inside the chamber CB are provided in each of the sections formed by the partition member 111. Each of the two sections also has a condition adjusting part connected thereto. The section with the slit nozzle disposed therein has a condition adjusting part AC1 connected thereto. The condition adjusting part AC1 is formed to have the same configuration as that of the condition adjusting part AC in the first embodiment.

The section provided with the heating part has a condition adjusting part AC2 connected thereto. In addition to the configuration of the condition adjusting part AC1 (or the condition adjusting part AC described in the first embodiment), the condition adjusting part AC2 has a branch conduit 125 which diverge from the conduit 34c. Thus, like the conduit 34c, the branch conduit 125 also allows the gas discharged by the discharge driving source 34a to flow therethrough.

The branched conduit 125 is connected to, for example, a heat accumulating mechanism 120. The branch conduit 125 is provided with a heating mechanism 121 which heats the gas flowing through the branch conduit 125. The branch conduit 125 may also be provided with a removing member which removes oxygen (e.g., a member having the same structure as that of the removing member 34d in the first embodiment).

The heating part DR has a heat accumulating mechanism 120 and a hot plate 130. The heat accumulating mechanism 120 is provided on the ceiling side of the chamber CB as viewed from the transporting region of the substrate S, and the hot plate 130 is provided on the bottom side of the chamber S as viewed from the transporting region of the substrate S. Like the heating part DR in the first embodiment, the hot plate 130 is provided with a heating mechanism (not shown).

The heat accumulating mechanism 120 is capable of accumulating the heat of the gas inside the chamber CB. The heat accumulating mechanism 120 is supplied with the gas which flows through the branch conduit 125. Thus, in the heat accumulating mechanism 120, the heat from the supplied gas is maintained at the same temperature as the temperature inside the chamber. The heat accumulating mechanism 120 has an opening on the −Z side thereof, and the gas from the branch conduit 125 is allowed to flow through the opening into the chamber CB.

In this embodiment, since the slit nozzle NZ and the heating part DR are provided in different sections, the coating step and the heating step are performed in different sections of a single chamber CB. In such a case, the control device CONT first performs the coating step of the substrate S in the section provided with the slit nozzle NZ. After the coating step has been completed, the control device CONT opens the cover portion 111a and transports the substrate S to the section provided with the heating part DR.

After the substrate S has been transported, the control device CONT closes the cover portion 111a and reduces the pressure inside the section provided with the heating part DR. After reducing the pressure, the control device CONT operates the heating part DR to perform the heating step of heating the liquid material on the substrate S. In the heating step, the substrate S is heated from the upper side and the bottom side by the heat accumulating mechanism 120 and the hot plate 130, respectively. In the heating step, the gas discharged from this section (e.g., inert gas) is supplied to the heat accumulating mechanism 120 through the branch conduit 125. The gas supplied to the heat accumulating mechanism 120 is heated by the accumulated heat, and the temperature of the gas is adjusted to about the same temperature as that inside this section (gas heating step). The heated gas is supplied into the section through the opening of the heat accumulating mechanism 120 to be reused. In the gas heating step, the gas may be heated using the heat mechanism 121 provided on the branch conduit 125.

After the heating step, the control device CONT stops the operation of the heating part DR and returns the pressure inside the chamber CB (the pressure inside the section) to atmospheric pressure. Thereafter, the control device CONT opens the cover portion 12a while maintaining the cover portion 111a closed, and transports the substrate S in the +X direction to unload the substrate S.

As described above, in the present embodiment, the substrate S is heated in a state where the substrate S is disposed between the heat accumulating mechanism 120 and the hot plate 130. In this manner, the liquid material on the substrate S can be efficiently dried. In addition, since the section provided with the slit nozzle NZ and the section provided with the heating part DR are separated by the partition member 110, even when the functions of the heating part DR are improved, the influence to the slit nozzle NZ can be suppressed. Moreover, by disposing the slit nozzle NZ and the heating part DR in different sections, for example, only the section which requires maintenance can be treated, so that maintenance can be performed efficiently.

The technical scope of the present invention is not limited to the above-described embodiment, but may be appropriately modified into various forms without departing from the spirit of the present invention.

For example, in the first embodiment, although the slit nozzle NZ and the heating part DR are disposed in the same space, the present invention is not limited to such a configuration. For example, as in the second embodiment, the inside of the chamber may be partitioned so as to dispose the slit nozzle NZ and the heating part DR in different sections. On the other hand, in the second embodiment, the slit nozzle and the heating part DR may be disposed in the same section.

Further, in the second embodiment, the gas supplied to the heat accumulating mechanism 120 is allowed to flow through the branch conduit 125 diverted from the conduit 34c, but the present invention is not limited thereto. For example, a flow path may be diverted from the conduit 33b of the condition adjusting part AC2.

Furthermore, in the second embodiment, the liquid material is heated from the upper side and lower side thereof respectively by the heat accumulating mechanism 120 and the hot plate 130, but the present invention is not limited thereto. For example, a configuration in which only one of the heat accumulating mechanism 120 and the hot plate 130 is provided can be used. Alternatively, in a configuration in which both of the heat accumulating mechanism and 120 and the hot plate 130 are provided, only one of them may be used to heat the liquid material.

Furthermore, in the above-described embodiments, the oxygen concentration inside the chamber CB is detected, and the supplying step is performed on the basis of the detection result. However, the present invention is not limited to such a configuration, and for example, the humidity inside the chamber CB may be detected, and the supplying step may be performed on the basis of the detected humidity. In this case, for example, the chamber CB is provided with a humidity sensor in addition to the oxygen concentration sensor 31. Alternatively, a humidity sensor may be disposed instead of the oxygen concentration sensor 31.

In the above-described embodiment, the coating part CT includes the slit nozzle NZ, but the present invention is not limited thereto. For example, a dispenser coating part or an ink jet coating part may be used. Alternatively, for example, the liquid material disposed on the substrate S may be diffused by using a squeezer or the like so as to be coated thereon.

In the above-described embodiment, the slit nozzle NZ constituting the coating part CT is fixed, but the present invention is not limited thereto. For example, a moving mechanism for moving the slit nozzle NZ may be provided so as to move the slit nozzle NZ.

In the above-described embodiment, the roller members 50 are used as the substrate transporting part TR, but the present invention is not limited thereto. For example, the substrate S may be transported by using a floating mechanism to lift the substrate S. In this case, the floating mechanism may be selectively disposed in an area where the slit nozzle NZ is disposed inside the chamber CB. By such a configuration, it is possible to precisely control the film thickness of the coating film formed on the substrate S.

While preferred embodiments of the present invention have been described and illustrated above, it should be understood that these are exemplary of the present invention and are not to be considered as limiting. Additions, omissions, substitutions, and other modifications can be made without departing from the spirit or scope of the present invention. Accordingly, the present invention is not to be considered as being limited by the foregoing description, and is only limited by the scope of the appended claims.

What is claimed is:

1. A coating method comprising:
coating a liquid material including an oxidizable metal on a substrate; and
heating the substrate having the liquid material coated thereon in the presence of an inert gas.

2. The coating method according to claim 1,
wherein the substrate is disposed inside the chamber while heating.

3. The coating method according to claim 2,
wherein heating the substrate is performed in an inert gas atmosphere.

4. The coating method according to claim 1,
wherein heating the substrate comprises supplying an inert gas to the surrounding atmosphere of the substrate.

5. The coating method according to claim 1,
wherein heating the substrate comprises discharging the gas in the surrounding atmosphere of the substrate.

6. The coating method according to claim 5,
wherein the discharged gas is returned to the surrounding atmosphere of the substrate.

7. The coating method according to claim 6,
wherein the discharged gas is heated before being returned to the surrounding atmosphere of the substrate.

8. The coating method according to claim 7,
wherein the discharged gas is heated by using excess heat in the surrounding atmosphere of the substrate.

9. The coating method according to claim 1,
wherein the substrate comprises a resin material, and
wherein heating the substrate is performed while maintaining the temperature inside the chamber at 300° C. or lower.

10. A coating apparatus comprising:
a coating part which applies a liquid material including an oxidizable metal to a substrate;
a chamber having a coating space in which the coating part applies the liquid material to the substrate and a transport space into which the substrate is transported;
a heating mechanism which heats the substrate inside the chamber; and
a control part which controls the coating part and the heating mechanism to heat the substrate having the liquid material coated thereon in the presence of an inert gas.

11. The coating apparatus according to claim 10, further comprising:
a supplying mechanism which supplies an inert gas into the chamber.

12. The coating apparatus according to claim 10, further comprising:
a discharging mechanism which discharges the gas inside the chamber.

13. The coating apparatus according to claim 12,
wherein the discharging mechanism includes a circulation path which returns the discharged gas to the surrounding atmosphere of the substrate.

14. The coating apparatus according to claim 13,
wherein the discharging mechanism has a gas heating mechanism which heats the discharged gas in the circulation path.

15. The coating apparatus according to claim 14,
wherein the gas heating mechanism has a heat accumulating mechanism which stores excess heat generated inside the chamber.

16. The coating apparatus according to claim 10,
wherein the substrate comprises a resin material, and
wherein the control part heats the inside of the chamber to a temperature of 300° C. or lower.
